(19) United States
(12) Patent Application Publication
(10) Pub. No.: US 2010/0078559 A1
(43) Pub. Date: Apr. 1, 2010

(54) Infra-red light stimulated high-flux semiconductor x-ray and gamma-ray radiation detector

(76) Inventors: Csaba Szeles, Allison Park, PA (US); Michael Prokesch, Gibsonia, PA (US); Derek Bale, Wexford, PA (US); Bruce Glick, Zelienople, PA (US); Carl Crawford, Bayside, WI (US)

Correspondence Address: Mark Levy;Hinman, Howard & Kattell, LLP, 80 Exchange Street, 700 Security Mutual Bldg., Binghamton, NY, 13901, US

(21) Appl. No.: 12/586,656

(22) Filed: Sep. 25, 2009

Related U.S. Application Data
(60) Provisional application No. 61/100,358, filed on Sep. 26, 2008.

(51) Int. Cl. G01T 7/00; G01T 1/00; G01T 1/24

(52) U.S. Cl. 250/338.4; 250/370.09; 250/341.5; 250/370.15; 250/371

(57) ABSTRACT

A method of detecting radiation through which the residence time of charge carriers is dramatically reduced by an external optical energy source and the occupancy of the deep-level defects is maintained close to the thermal equilibrium of the un-irradiated device even under high-flux exposure conditions. Instead of relying on thermal energy to release the trapped carriers, infra-red light radiation is used to provide sufficient energy for the trapped carriers to escape from defect levels. Cd₁₋ₓZnₓTe crystals are transparent to infra-red light of this energy and no additional absorption occurs other than the one associated with the ionization of the targeted deep-level defects. This allows irradiation geometry from the side source of the Cd₁₋ₓZnₓTe detector crystals.

### RELATED APPLICATION

The present patent application is a continuation-in-part of U.S. provisional patent application Ser. No. 61/100,358, filed Sep. 26, 2008, hereby incorporated, and claims the priority date thereof.

### FIELD OF INVENTION

The present invention relates to detecting radiation and, more specifically, to a method by which infra-red light radiation is used to provide sufficient energy for trapped charge carriers to escape from defects levels.

### BACKGROUND OF THE INVENTION

Historically, semi-insulating Cd₁₋ₓZnₓTe crystals (where 0≦x<1) with Zn composition in the 0≦x≦0.25 mole fraction range are typically used for room-temperature semiconductor radiation detector applications. In order to be useful for x-ray and gamma-ray detectors the Cd₁₋ₓZnₓTe crystals must be electrically compensated to bring them to a highly resistive state so that the equilibrium residual free carrier concentration is much lower than that of the free carriers generated by the impinging x-rays and gamma-rays. The high-resistivity state can be achieved by various doping recipes that are described in numerous publications and patents. All of these doping methods work on the principle of deep level defect electrical compensation. Using this method a relatively modest amount of deep-level defects is incorporated near the middle of the band gap of the Cd₁₋ₓZnₓTe crystals. These deep-level defects permanently capture the charge carriers and reduce the residual net free carrier concentration to the 10⁵ cm⁻³ range. The defects with deep electronic levels can be native defects and defect complexes consisting entirely of native atoms such as interstitial atoms, anti-site atoms and vacancies, or can be foreign impurities or their complexes with native defects.

In pulse-mode semiconductor detectors, the detector consists of a slab of semiconductor material with electrodes on the opposite faces of the semiconductor. The detector material is depleted in free carriers and an electric field is applied between the electrodes using an outside bias. High-energy photons from an outside radioactive source or x-ray tube induce electron-hole pairs in the semiconductor volume through photoelectric or Compton interactions. The interaction is a two-step process where the high-energy electrons created in the photoelectric or Compton event lose their energy through repeated electron-hole ionization. Due to the high cross section of this process, the electron-hole pairs form a highly localized charge cloud only few micro-meters in diameter.

The most important aspect of the photon interaction for spectroscopy is that the number of electron-hole pairs is proportional to the photon energy in the photoelectric effect. The charge cloud of electrons and holes is separated in the electric field and the electrons and holes move toward opposite electrodes, creating a temporary current through the device. This current is typically integrated by a charge-sensitive preamplifier to measure the total charge induced by the outside radiation. A voltage pulse is produced with amplitude proportional to the total induced charge. This voltage pulse is amplified and collected as a histogram in a multi-channel analyzer.

Photons with various energies produce voltage pulses in the preamplifier with various amplitude and individual peaks with various peak positions in the multi-channel analyzer. Fluctuation in the pulse amplitude due to electronic noise results in a broadening of the energy peak, while charge loss in the detector due to trapping or recombination results in reduced pulse amplitude and a low energy tail in the energy peak.

The short residence time of the carriers at the deep defect levels achieved by the infra-red radiation benefits the performance of the detector device in a number of ways. First, under high-flux operating conditions such as in medical, security and industrial Computed Tomography, photon fluxes in many millions of photons per second per square millimeter are used. Under such conditions, hole trapping in Cd₁₋ₓZnₓTe detectors causes a space-charge formation and a potential temporary paralysis of the device called polarization. By infra-red radiation with suitably tuned photon energy to the ionization energy of deep-level defects, such space-charge formation can be suppressed and the useful flux range of the device can be extended.

Further, devices that show polarization for 1 million photons per second per square mm can be operated at 1000 times the photon flux at 1 billion photons per second per square mm. For high speed x-ray imaging such as medical, security and industrial Computed Tomography, the short response time of the device to photon flux changes is absolutely essential. Response times to sudden flux increases and decreases in the sub milliseconds range are required. This, as discussed above, is not necessarily achievable in fully compensated high-resistivity Cd₁₋ₓZnₓTe crystals with the relatively high concentration of deep level defects. Using infra-red radiation of suitable energy in the (0.6-0.8) eV range, the residence time of the trapped carriers can be dramatically reduced and hence the response time of the devices can be dramatically shortened.

Thus, one benefit of the invention lies in the active control of the occupancy of deep level defects by using a suitably tuned infra-red light source to improve the high-flux x-ray and gamma-ray temporal response and the polarization threshold of the detector devices and to extend their operating range to higher fluxes. By tuning the infra-red energy to defect levels of specific energy, adequate stimulation of these defect levels is selectively achieved. This way either or both electron or hole trapping at deep-level defects can be suppressed and the residence time of the trapped carriers can be reduced.

To Applicants' knowledge, no outside light stimulated high-flux Cd₁₋ₓZnₓTe detector devices have been proposed, discussed in the literature, designed or sold in the marketplace. This active light stimulation and the infra-red radiation tuned in energy to specific deep-level defects are the core ideas of this invention.

United States Patent Publication No. 2006/0289773 for METHOD AND APPARATUS FOR REDUCING POLARIZATION WITHIN AN IMAGING DEVICE by Ira Blevis describes a method to apply heat to semiconductor detectors to suppress polarization of the device. But this application does not discuss beneficial effects of temperature stimulated detrapping on the temporal response and response speed of the semiconductor detector.

By suppressing electron and hole trapping and reducing the residence time of the trapped carriers in the current invention, the high-flux x-ray and gamma-ray temporal response and polarization threshold of the devices can be improved. In addition, the operating range of the Cd₁₋ₓZnₓTe detectors can be extended to higher fluxes.

Further, the invention increases both the yield of useful detector crystals from a given material-properties distribution of available crystals and the performance characteristics of then fabricated detector devices. Both of these are core improvements of Cd₁₋ₓZnₓTe radiation detector technologies and significantly improve the performance and manufacturing price of the detectors. The invention therefore allows new applications, in particular, the use of Cd₁₋ₓZnₓTe for medical and security CT.

### SUMMARY OF THE INVENTION

The present invention is a method by which the residence time of charge carriers is dramatically reduced by an external optical energy source and the occupancy of the deep level defects is maintained close to the thermal equilibrium of the un-irradiated device even under high-flux exposure conditions. The detector includes a radiation detector comprising an external optical energy source to provide sufficient energy for trapped charged carriers to escape from defect levels and crystals that are transparent to the light of the energy source allowing no additional absorption.

In the method, instead of relying on thermal energy to release the trapped carriers, infra-red light radiation is used to provide sufficient energy for the trapped carriers to escape from the defect levels. The energy of the infra-red light source is tuned to the (0.6-0.8) eV range corresponding to the ionization energy of the deep-level defects in the middle of the band gap. The Cd₁₋ₓZnₓTe crystals are transparent to infra-red light of this energy and no additional absorption occurs other than the one associated with the ionization of the targeted deep-level defects. Because of this low absorption, the infra-red irradiation can be performed through any surface of the crystal that is transparent to the infra-red light. This conveniently allows irradiation geometry from the side surface of the Cd₁₋ₓZnₓTe detector crystals. The intensity of the infra-red radiation is tuned to maintain the thermal equilibrium occupancy of the deep-level defect without generating excessive photocurrent in the device from the infra-red radiation.

Under normal, no infra-red, illumination, the x-ray induced photocurrent reaches a maximum at the onset of x-rays followed by a steady decay to a stationary condition with a time constant of a few tens of milliseconds. However, the same detector when exposed to constant infra-red illumination instantaneously reaches the steady state condition without further temporal transient of the photocurrent. Thus, the stimulation required to establish a significant steady-state infra-red photocurrent is well above the equilibrium dark current. The time-dependent response is a function of the infra-red excitation intensity and can be optimized for the characteristics of the crystal. In a pulse-counting experiment, the count-rate stabilizes at the same time scale or faster than the photocurrent for the same detector. An initial ˜2 ms delay is caused by the x-ray shutter.

Two embodiments of side irradiation of pixilated monolithic Cd₁₋ₓZnₓTe detector arrays are provided herein. One embodiment includes sidewall infra-red irradiation geometry. The second embodiment uses corner infra-red illumination. These illumination geometries can be applied to both individual monolithic detectors and an array of tiled detectors.

Infra-red illumination through the full area electrode or the pixel electrodes is also conceivable by using semi-transparent electrode materials such as thin films or Indium Tin Oxide (ITO). However because the full area electrode is the entrance window of x-rays and gamma-rays, the light source causes unwanted absorption. On the pixel electrode surface the design of the light path represents a challenge because the pixels are bonded to a substrate or a read-out electronics chip.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view showing the operation principle of semi-insulating detectors;

FIG. 2 is a graphical depiction of a detector response (counting-rate) to a step increase and decrease to a photon flux;

FIG. 3 is a graph that depicts the residence time of carriers as the function defect ionization energy, the electron and hole transit times being given for a typical parallel plate detector for a typical bias voltage;

FIG. 4 is a schematic depiction of a typical defect structure of the Cd₁₋ₓZnₓTe band gap;

FIG. 5 is a schematic representation of a thermally activated escape (detrapping) of trapped electrons and holes from deep-level defects in Cd₁₋ₓZnₓTe;

FIG. 6 is a schematic representation of an infra-red slight stimulated escape (detrapping) of trapped electrons and holes from deep-level defects in Cd₁₋ₓZnₓTe;

FIG. 7 is an x-ray photo current response of a normally slow responding planar CZT detector to a sudden ultra-high flux exposure of 1×10⁸ photons/(mm²*s) under standard conditions (without infra-red illumination) and with infrared light stimulation;

FIGS. 8a and 8b depict a typical pixelated monolithic Cd₁₋ₓZnₓTe detector array geometry and a typical embodiment of tiling of such detector arrays, respectively; and

FIGS. 9a-9b show two embodiments of sidewall and corner irradiation of pixelated monolithic Cd₁₋ₓZnₓTe detector arrays.

### DETAILED DESCRIPTION OF THE PREFERRED EMBODIMENT

The present invention is described with reference to the accompanying figures where like reference numbers correspond to like elements.

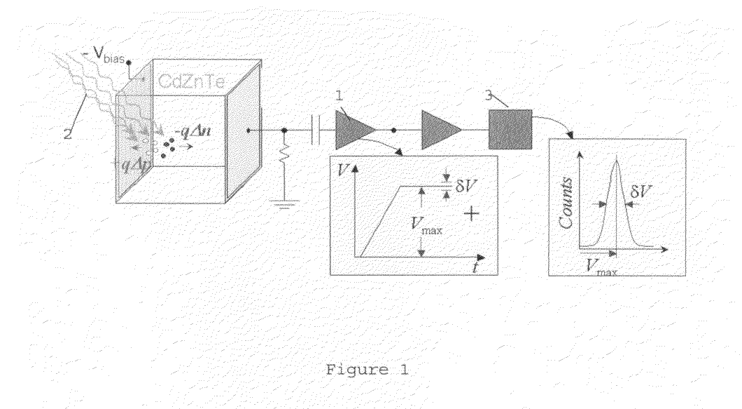

The operation principle of typical pulse-mode semiconductor detectors is shown in FIG. 1. Current is typically integrated by a charge sensitive preamplifier 1 to measure the total charge induced by the outside radiation 3 and produces a voltage pulse (not shown) with amplitude proportional to the total induced charge. Photons with various energies produce voltage pulses in the preamplifier 1 with various amplitude and individual peaks with various peak positions in the multi-channel analyzer 3. Fluctuation in the pulse amplitude due to electronic noise results in a broadening of the energy peak, while charge loss in the detector due to trapping or recombination results in reduced pulse amplitude and a low energy tail in the energy peak.

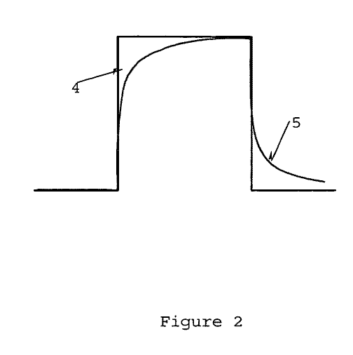

FIG. 2 illustrates the situation when high-speed, high-flux x-ray applications, such as diagnostic computer tomography, require detector response times on the order of micro-seconds to a few milliseconds range. In an ideal x-ray imaging system, the photon count-rate of the detector must follow instantaneously a step-change in the photon flux 4. Similarly, when the photon flux 4 is suddenly decreased, the decrease of the counts 5 is gradual (response time to decreasing flux) and some delayed counts are reported by the detector even after the photon flux 4 is decreased or completely stopped. The delayed response of the detector to the instantaneous change in the photon flux 4 is caused by the response characteristics of the carriers 9 in the detector device. The built-in deep-level defects 8 of the present invention, therefore, necessarily gives rise to delayed charge emission, and therefore delayed count-rate characteristic time scales on the order of (0.01-1.0) seconds, causing the delayed count-rate response of the detectors as illustrated in FIG. 2.

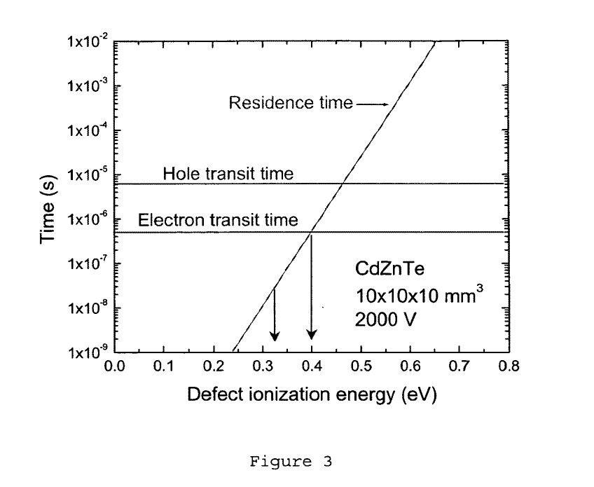

FIG. 3 shows that the residence time of carriers 9 as a function of the thermal ionization energy (energy difference to the edge of the band gap) of the various defect levels 6, 7, and 8. The long time scale associated with emptying of the deep-level defects 8 is the primary concern for the applications of Cd₁₋ₓZnₓTe semiconductor detectors.

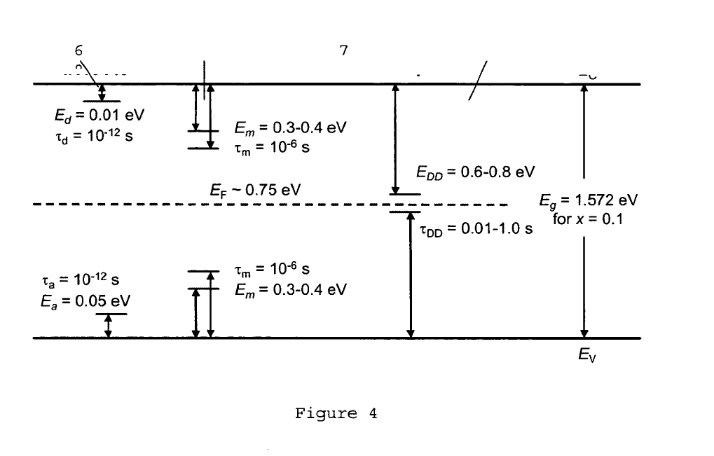

FIG. 4 illustrates the typical defect structure of the Cd₁₋ₓZnₓTe band gap. E_{g} denotes the band gap energy, Eᵥ and E_{c} denote the energy of the valence band and conduction band edges, respectively. E_{F} denotes the Fermi level (average energy of the electrons and holes) and the dashed line shows the position of the Fermi levels in thermal equilibrium in a fully compensated (high resistivity) Cd₁₋ₓZnₓTe crystal. The arrows show the trapping and detrapping associated with the various defect levels. Shallow-level defects 6, mid-level defects 7 and deep-defect levels 8 are shown with the typical ionization energies and characteristic residence times of trapped carriers 9.

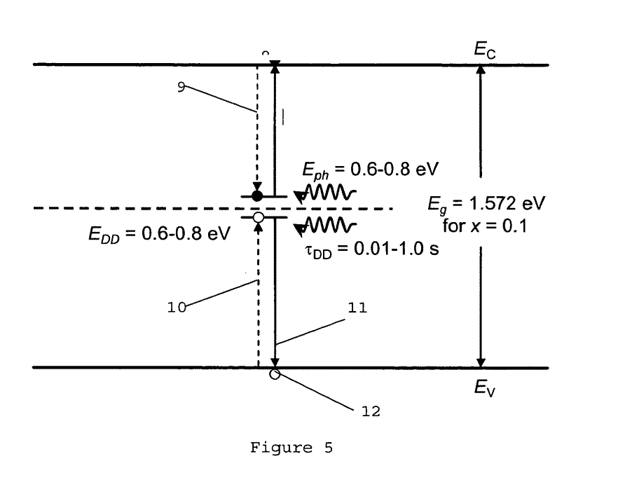

As shown in FIG. 5, the carriers 9 eventually acquire the necessary thermal energy from the crystal (not shown) and escape to the valence or conduction band (de-trapping) 11. Typically, the energy needed for the trapped carriers 9 and holes 10 at deep-level defects 8 is large compared to the available thermal energy. As a result, the probability to acquire the necessary thermal energy is low, resulting in a long residence time of the carriers 9 in the trapped state.

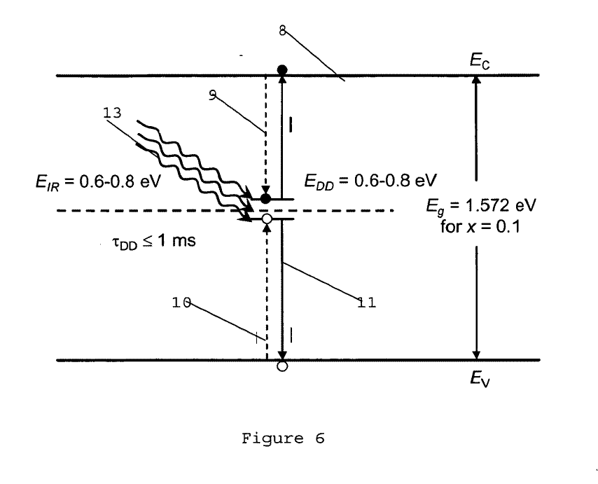

FIG. 6 illustrates the high flux semiconductor radiation detector 19 method. Infra-red light radiation 13 is used to provide sufficient energy for the trapped carriers 9 to escape from the defect levels. The energy of the infra-red light source 13 is tuned to the 0.6-0.8 eV range corresponding to the ionization energy of the deep-level defects 8 in the middle of the band gap.

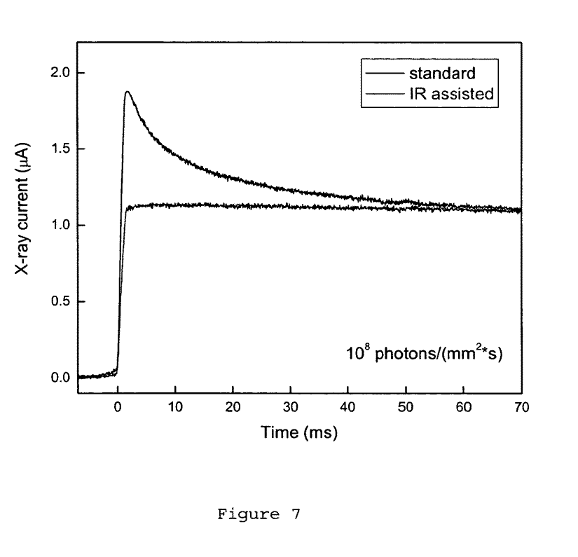

FIG. 7 shows the x-ray photo current response of a normally slow-responding planar CdZnTe detector to a sudden ultra-high flux exposure of 1×10⁸ photons/(mm²*s) without and with infrared light stimulation. Under normal, no infra-red, illumination, the x-ray induced photocurrent reaches a maximum at the onset of x-rays followed by a steady decay to a stationary condition with a time constant of a few tens of milliseconds. The same detector, when exposed to constant infra-red illumination, instantaneously reaches the steady state condition without further temporal transient of the photocurrent. The response timing depends on the infra-red excitation (esp., intensity) and can be optimized. In a pulse counting experiment, the count-rate stabilizes at the same time scale or faster than the photocurrent. The initial ˜2 ms delay is caused by the X-ray shutter.

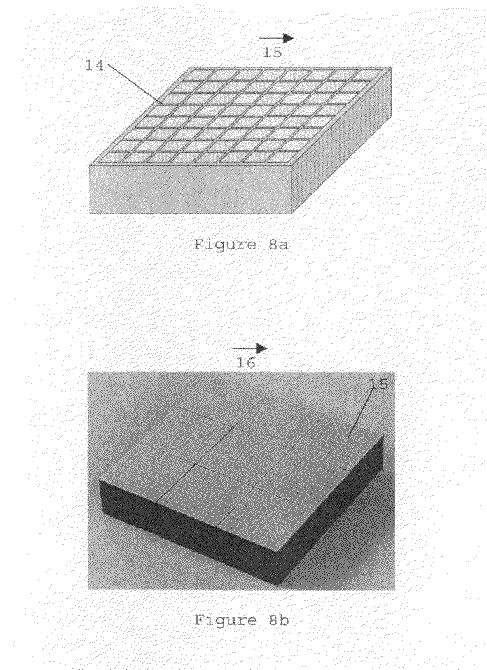

FIG. 8a shows a typical pixilated 14 monolithic Cd₁₋ₓZnₓTe detector array geometry 15. FIG. 8b shows a typical embodiment 16 of tiling of such detector arrays 15.

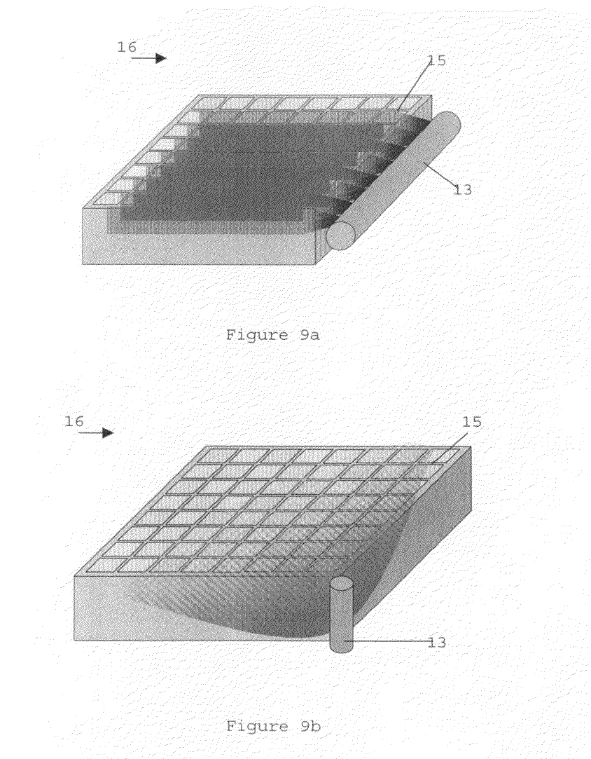

FIGS. 9a and 9b show two possible embodiments of side irradiation of pixilated 14 monolithic Cd₁₋ₓZnₓTe detector arrays 15, respectively. FIG. 9a shows possible sidewall infra-red irradiation by the infra-red light source 13, whereas FIG. 9b illustrates corner infra-red illumination geometry by the infra-red light source 13. These illumination geometries can be applied to both individual monolithic detectors and an array of tiled detectors.

Since other modifications and changes varied to fit particular requirements and environments will be apparent to those skilled in the art, the invention is not considered limited to the example chosen for the purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A radiation detector comprising:
an external optical energy source to provide sufficient energy for trapped charged carriers to escape from defect levels; and
crystals that are transparent to the light of the energy source, allowing no additional absorption.

2. The radiation detector of claim 1, wherein the external optical energy source is an infra-red light source.

3. The radiation detector of claim 2, wherein the infra-red light source is tuned within the band gap energy range of 0.6-0.8 eV.

4. The radiation detector of claim 3, wherein said crystals comprise Cadmium Zinc Telluride.

5. A radiation detector comprising:
an external optical energy source to provide sufficient energy for trapped charged carriers to escape from defect levels; and
electrode materials that are semi-transparent to the light of the energy source.

6. The radiation detector of claim 5, wherein the external optional energy source is an infra-red light source.

7. The radiation detector of claim 6, wherein the semi-transparent electrode materials are chosen from the group: thin films and Indium Tin Oxide.

8. The radiation detector of claim 7, further comprising electrode materials that include one of the group: a full area electrode and pixel electrode area.

9. The radiation detector of claim 5, wherein the energy of the infra-red light source is tuned to the 0.6-0.8 eV range.

10. A method of stimulating a high-flux semiconductor in order to detect radiation comprising an infra-red light radiation source and transparent crystals, the method comprising:
a) tuning the intensity of the infra-red radiation in the 0.6-0.8 eV range to maintain the thermal equilibrium occupancy of the deep-level defects in the middle band gap;
b) causing no additional absorption or excessive photocurrent to occur in the device other than the one associated with the ionization of the targeted deep-level defects via the transparent crystals;
c) allowing infra-red light irradiation to be performed through at least one surface of the crystal; and
d) providing sufficient energy for trapped carriers to escape form the defect levels.
